(19) United States
(12) Patent Application Publication
(10) Pub. No.: US 2019/0217678 A1
(43) Pub. Date: Jul. 18, 2019

(54) COMPENSATING METHOD FOR A MOTOR VEHICLE AND MOTOR VEHICLE

(71) Applicant: FORD GLOBAL TECHNOLOGIES, LLC, Dearborn, MI (US)

(72) Inventors: Marcus KALABIS, Krefeld NRW (DE); Martin SAEGER, Pulheim NRW (DE); Michael SEEMANN, Cologne NRW (DE); Felix WEINREICH, Dortmund NRW (DE); Simon BAALES, Cologne NRW (DE); Alex FISCHER, Monheim NRW (DE); Matthias DEHMEL, Pulheim NRW (DE); Uwe HOFFMANN, Leverkusen NRW (DE)

(73) Assignee: FORD GLOBAL TECHNOLOGIES, LLC, Dearborn, MI (US)

(21) Appl. No.: 16/244,573

(22) Filed: Jan. 10, 2019

(30) Foreign Application Priority Data
Jan. 12, 2018 (DE) 10 2018 200 442.0

(51) Int. Cl. B60G 17/015

(52) U.S. Cl. CPC B60G 17/0157; F16D 2121/24

(57) ABSTRACT

A compensating method is provided for avoiding a bouncing movement of a wheel of a motor vehicle. The motor vehicle comprises an unsprung mass (m) that is attached in a movable manner to a sprung mass, wherein the unsprung mass (m) comprises the wheel, and an actuator that is embodied so as to apply a force (K) between the sprung mass and the unsprung mass (m). During a movement of the unsprung mass (m) relative to the sprung mass in an application of force by means of the open loop control of the actuator by the method, a force (K) is applied between the sprung mass and the unsprung mass (m) so as to damp the movement. A motor vehicle implementing the method is also provided.

### CROSS-REFERENCE TO RELATED APPLICATIONS

This application claims foreign priority benefits under 35 U.S.C. § 119(a)-(d) to DE Application 10 2018 200 442.0 filed Jan. 12, 2018, which is hereby incorporated by reference in its entirety.

### TECHNICAL FIELD

Various embodiments relate to a method for avoiding a bouncing movement of a wheel of a motor vehicle and also a motor vehicle for implementing the compensating method.

### BACKGROUND

DE 112012007083 T5 discloses a method for compensating for adverse effects on the straight line travel of a motor vehicle whilst the motor vehicle is driving along a road that is inclined and/or cambered in a direction that is transverse with respect to the road longitudinal direction. The reference discloses a speed closed loop control procedure for a motor vehicle that is steered automatically, said speed closed loop control procedure including a tilt control for reducing the angle of inclination on a road that is inclined to the side, wherein the inclination of the road is determined by means of sensors.

### SUMMARY

The object of the present disclosure is to provide a compensating method and a motor vehicle with which a bouncing movement of a wheel of the motor vehicle is prevented.

This object is achieved with a compensating method and a motor vehicle as described below.

The compensating method in accordance with the disclosure is provided so as to avoid a bouncing movement of a wheel of a motor vehicle that comprises an unsprung mass that is attached in a movable manner to a sprung mass, wherein the unsprung mass comprises the wheel and comprises an actuator that is configured so as to apply a force between the sprung mass and the unsprung mass. In the case of the compensating method in accordance with the invention during a movement of the unsprung mass relative to the sprung mass in an application of force by means of the open loop control of the actuator a force is applied between the sprung mass and the unsprung mass so as to damp the movement.

As a consequence, the behavior of the chassis and therefore the driving behavior of the motor vehicle may be influenced.

In one advantageous embodiment of the compensating method in accordance with the invention, the force is applied in dependence upon a frequency of the movement of the unsprung mass.

As a consequence, it is possible to expediently exert influence according to the type of movement.

In a further advantageous embodiment of the compensating method in accordance with the invention a transfer function is used for the open loop control of the actuator,

$${G}_{A} ( s ) = \frac{2 \frac{δ}{{ω}_{0}} s + 1}{\frac{1}{{ω}_{0}^{2}} {s}^{2} + 2 \frac{δ}{{ω}_{0}} s + 1}$$

wherein

$$δ = \frac{d}{2 m} and {ω}_{0} = \sqrt{\frac{c}{m}}$$

and wherein m is the unsprung mass and c is a tire spring stiffness and d is a tire damping coefficient.

This equation describes the amplitude of a signal as a function of the excitation frequency. The frequency is an excitation or vibrational frequency, and is not a rotational frequency. The amplitude of the signal may be adjusted by means of using this equation and therefore a frequency-dependent damping force may be applied.

In a further advantageous embodiment of the compensating method in accordance with the invention, a transfer function is used for the open loop control of the actuator as:

$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} .$$

This equation describes the manipulation of the signal phase in the case of an amplitude that is as unchanged as possible. The phase of the signal can be adjusted by means of using this equation.

In a further advantageous embodiment of the compensating method in accordance with the invention, a transfer function is used for the open loop control of the actuator as:

$${G}_{F} ( s ) = \frac{{a}_{A 1} {a}_{P 2} {s}^{3} + ( {a}_{A 1} {a}_{P 1} + {a}_{A 0} {a}_{P 2} ) {s}^{2} + ( {a}_{A 1} {a}_{P 0} + {a}_{A 0} {a}_{P 1} ) s + {a}_{A 0} {a}_{P 0}}{\begin{matrix}{b}_{A 2} {b}_{P 2} {s}^{4} + ( {b}_{A 2} {b}_{P 1} + {b}_{A 1} {b}_{P 2} ) {s}^{3} + ( {b}_{A 2} {b}_{P 0} + {b}_{A 1} {b}_{P 1} + {b}_{A 0} {b}_{P 2} ) {s}^{2} + \\ ( {b}_{A 1} {b}_{P 0} + {b}_{A 0} {b}_{P 1} ) s + {b}_{A 0} {b}_{P 0}\end{matrix}} .$$

This equation is the product of the two preceding equations.

G_{F}(s)=G_{A}(s)·G_{P}(s)

wherein

$${G}_{A} ( s ) = \frac{{a}_{A 1} s + {a}_{A 0}}{{b}_{A 2} {s}^{2} + {b}_{A 1} s + {b}_{A 0}}$$

$$and$$

$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} .$$

As a consequence, both the amplitude as well as the phase of the signal may be influenced. The advantage resides in the fact that the two equations may be parameterized separately in a simpler manner. It is clearly more manageable, than the alternative procedure, to represent a polynomial of the fifth order empirically.

The motor vehicle in accordance with the disclosure is embodied so as to implement the compensating method in accordance with the invention in all the embodiment variants. The motor vehicle comprises a sprung mass and at least one unsprung mass and an actuator that is embodied so as to apply a force between the sprung mass and the unsprung mass.

A motor vehicle is therefore provided that benefits from the advantages of the compensating method of the present disclosure when implementing the compensating method and also provides an improved driving behavior of the vehicle.

In an advantageous embodiment of the motor vehicle of the present disclosure, the actuator is operated in an electrical manner. It is therefore rendered possible to implement the open loop control signals as rapidly as possible.

Further advantages of the present disclosure are apparent in the detailed description and the illustrations. The invention is further explained with reference to the illustrations and the following description.

### BRIEF DESCRIPTION OF THE DRAWINGS

FIG. 1 illustrates a motor vehicle according to an embodiment;

FIG. 2 illustrates a compensating method according to an embodiment and for use with the vehicle of FIG. 1; and

FIG. 3 illustrates exemplary curves of the equations A, P and F in a Bode diagram.

### DETAILED DESCRIPTION

As required, detailed embodiments of the present disclosure are provided herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

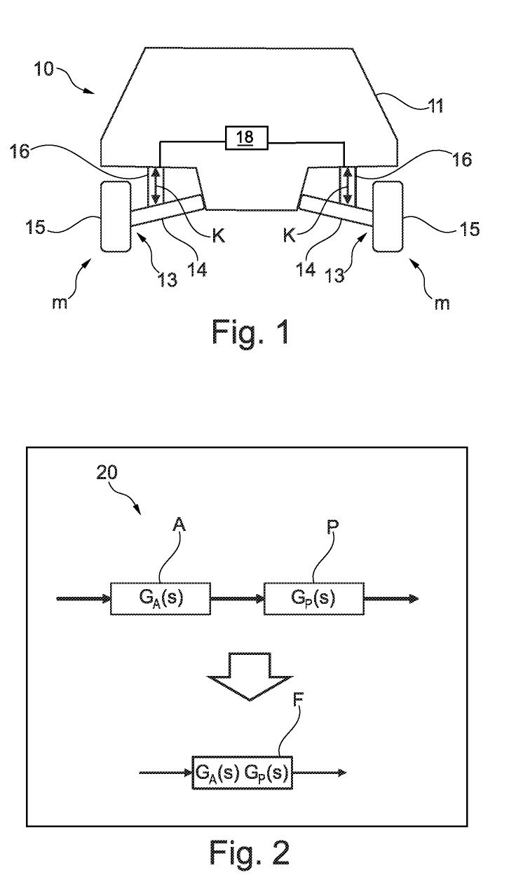

FIG. 1 illustrates schematically a motor vehicle 10 in accordance with the present disclosure and according to an embodiment. The motor vehicle 10 includes a sprung mass 11 and at least one unsprung mass m. The unsprung mass m is in this case attached to the unsprung mass 11 in a movable manner, and the unsprung mass m may be provided by the wheel 15, which includes the wheel and tire assembly.

The unsprung mass m acts in an unsprung manner on the road or underlying surface whilst the motor vehicle 10 is driving. The suspension of the sprung mass 11 is in this case achieved by means of a chassis 13 that supports at least one wheel 15 of the motor vehicle 10 against the sprung mass 11. A wheel suspension arrangement 14 and an actuator 16 is in this case part of the chassis 13, said actuator 16 being embodied so as to apply a varying force K between the sprung mass 11 and the unsprung mass m. The actuator 16 is in particular operated in an electrical manner, e.g. is an electrical actuator. A control unit 18 individually controls the motion of each actuator 16.

The motor vehicle 10 is embodied, so as to exert a compensating method 20 in accordance with the present disclosure as implemented by the control unit 18 controlling the motion of the actuators 16. In particular, the motor vehicle 10 comprises a control unit 18 for the open loop control of the compensating method 20. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

The control diagram for the compensating method 20 is illustrated in an exemplary embodiment in FIG. 2. The compensating method 20 is an open loop control procedure in which a predefined transfer function is used by the control unit 18 to control the electrical actuators 16.

In the compensating method 20 in accordance with the present disclosure, the actuator 16 of the motor vehicle 10 is open loop controlled by the control unit 18 in such a manner that the unsprung mass m, or associated wheel, is damped during a movement relative to the sprung mass 11, or remainder of the vehicle. The actuator 16 applies a force K for this purpose between the unsprung mass m and the sprung mass 11. The force K may be changed over the time and may be a pulling force and/or a pushing force.

The control unit 18 controls the actuator to apply a force K in dependence upon the frequency of the movement of the unsprung mass m. In particular, an equation A is used as a transfer function in the open loop control procedure so as to apply the force K, wherein according to the equation A:

$${G}_{A} ( s ) = \frac{{a}_{A 1} s + {a}_{A 0}}{{b}_{A 2} {s}^{2} + {b}_{A 1} s + {b}_{A 0}} = \frac{2 \frac{δ}{{ω}_{0}} s + 1}{\frac{1}{{ω}_{0}^{2}} {s}^{2} + 2 \frac{δ}{{ω}_{0}} s + 1}$$

In this case

$$δ = \frac{d}{2 m} , {ω}_{0} = \sqrt{\frac{c}{m}} ,$$

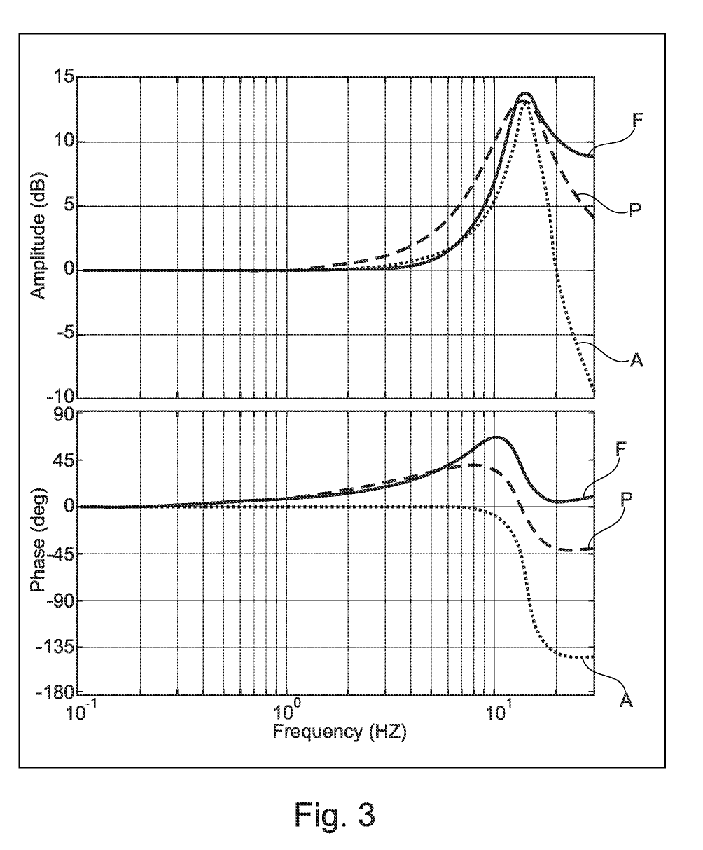

m=unsprung mass, c=tire spring stiffness, d=tire damping coefficient. The symbol s refers to the frequency, a is a coefficient of the summands of the numerator and b is a coefficient of the summands of the denominator. The equation A is illustrated in FIG. 3 in graphical form.

In the compensating method 20 it is also possible that an equation P is used as a transfer function in the open loop control of the actuator 16. According to the equation P:

$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}}$$

The equation P is illustrated in FIG. 3 in graphical form. The symbol s refers to the frequency. The numerical values of the coefficients from equation P are not linked physically to any parameters, and are predefined as constant values in such a manner in order to achieve the desired dynamic behavior of the entire system or vehicle. The values of the coefficients for equation P may be empirically determined for use with the vehicle to provide an accurate model for equation P.

It is preferred that an equation F is used as a transfer function by the control unit 18 in controlling the actuators 16. The equation F describes a frequency-dependent, wheel bouncing, open loop control procedure having a deceleration compensation. Equation F is a product of equation A and equation P as described above. According to equation F:

$${G}_{F} ( s ) = {G}_{A} ( s ) \cdot {G}_{P} ( s ) = \frac{\begin{matrix}{a}_{A 1} {a}_{P 2} {s}^{3} + ( {a}_{A 1} {a}_{P 1} + {a}_{A 0} {a}_{P 2} ) {s}^{2} + \\ ( {a}_{A 1} {a}_{P 0} + {a}_{A 0} {a}_{P 1} ) s + {a}_{A 0} {a}_{P 0}\end{matrix}}{\begin{matrix}{b}_{A 2} {b}_{P 2} {s}^{4} + ( {b}_{A 2} {b}_{P 1} + {b}_{A 1} {b}_{P 2} ) {s}^{3} + \\ ( {b}_{A 2} {b}_{P 0} + {b}_{A 1} {b}_{P 1} + {b}_{A 0} {b}_{P 2} ) {s}^{2} + \\ ( {b}_{A 1} {b}_{P 0} + {b}_{A 0} {b}_{P 1} ) s + {b}_{A 0} {b}_{P 0}\end{matrix}} .$$

The equation F is likewise illustrated in FIG. 3 in graphical form. The wheel bouncing frequency is predefined. The wheel bouncing frequency is essentially dependent upon the variable of the unsprung mass m, that is measured and/or calculated and the tire spring stiffness that is calculated and/or measured.

By way of an example, the present disclosure aims to reduce or eliminate “wheel hop” in a vehicle. Wheel hop describes the vertical oscillation of a wheel at its resonance frequency, which decreases both driving comfort by excitation of the sprung mass and driving safety by the resulting dynamic wheel load changes, which decrease the capability of force transfer between wheel and road. Hence, apart from passive compensation by appropriate damper configuration, active wheel hop control according to the present disclosure provides benefits with respect to vehicle dynamics. The present disclosure provides a control unit 18 that implements a method to manipulate the oscillations of unsprung and sprung masses by applying an active force between these masses, which causes unavoidable interdependencies.

The control unit 18 calculates the amount and actuation of the force via an open loop control. The vehicle control unit 18 includes one or more sensors, one or more electronic controls units (ECU), a communication network, and an actuator between the sprung and unsprung masses. For any real control loop, a force actuation is not instantaneous due to latencies in the system. Latencies may be caused by dynamics of a sensor, signal run-time in the communication network, processing time of the ECU, and/or rise time of the actuator 16 to produce the requested force.

According to an example, an automotive control loop typically does not provide an overall latency faster than 10 milliseconds (ms), but depending on the control task this short latency already might be troublesome. When describing oscillations in frequency domain, the issue becomes clearly visible. For actuations in the range of a sprung mass resonance frequency around 1.5 Hertz (Hz), a control latency of 10 ms results in a phase lag of approximate 5 degrees, which may be considered acceptable. However, if the wheel resonance frequency is increased, e.g. to 13 Hz, the same control latency of 10 ms results in a phase lag of more than 45 degrees. This amount of phase lag may not be considered acceptable as the force is actuated too late, and either prevents a complete compensation of the disturbance, or at least increases the power demand of the actuator.

The present disclosure provides a control method as implemented by the control unit by assuming that for wheel hop control, an actuation force is only desired for the wheel hop frequency band. Then, by application of the following design method, an appropriate numerical filter, which considers both the force amplitude and phase as functions of the input frequency, is provided and implemented by the control unit 18.

First, the wheel hop frequency is identified. The wheel hop frequency may mainly depend on the unsprung mass and the tire stiffness. The wheel hop frequency may be measured by a sensor.

Second, a transfer function is defined with a local peak gain at the wheel hop frequency for the actuator force as a function of the suspension velocity. The transfer function may be scaled with a low gain to yield the frequency dependent wheel hop controller without lag compensation, as described above with reference to Equation A.

Thirdly, the phase of the wheel hop controller from step two above is tuned to provide a phase of zero degrees in the wheel resonance frequency by multiplying a lag lead compensator of 2nd order, as shown in Equation P. The result is the frequency dependent wheel hop controller with lag compensation, as shown in Equation F. The control unit implementing an open loop control method with Equation F is applied to actuator, and the results are measured.

Fourthly, the measured results are analyzed by approximation of a transfer function in the frequency domain to calculate a phase lag for the system. The calculated phase lag provides a representation of the overall system latency.

Fifthly, the lag lead compensator (as used in step three, Equation P) is re-tuned to produce a phase lag of zero degrees for the transfer function as shown in Equation F. The filter's order remains unchanged.

Finally, the wheel hop control unit is updated to include and account for lag compensation by using the re-tuned lag lead compensator and apply the new control method and transfer function F to the system.

Conventionally, to cover the requirements on gain and phase over the relevant frequency band, a filter of higher order is necessary. However, polynomials in a Laplace function with a 3rd order numerator and a 4th order denominator are not intuitively tunable. The present disclosure provides various advantages. According to one non-limiting advantage, the gain and phase of the control filter is done by two separate functions, which are able to be managed and tuned as higher order polynomials are not present. The results are visualized by the Bode plots of the controller variations for the relevant frequencies 0.1 Hz-30 Hz, as shown in FIG. 3, with Equations A, P, and F shown.

Additionally, by applying the frequency dependent control method to the actuator as described herein, ride comfort and driveability are increased, and power consumption by the actuator is decreased. When applying an active suspension actuator in a vehicle in the damper path without frequency dependent controls, any damper force will be applied over the entire bandwidth that an actuator is capable to produce, which increases the power demand of such a system unnecessarily and decreases the ride comfort as the suspension might stiffen in frequency bands where it should isolate the vehicle body instead of compensate the wheel movement.

Although the invention has been further illustrated and described in detail by means of the preferred exemplary embodiments, the invention is not thus limited by the disclosed examples and other variations may be derived therefrom by the person skilled in the art without departing the protective scope of the invention.

The figures are not necessarily accurate in every detail and to scale and may be enlarged or reduced in size in order to offer improved clarity. Disclosed functional details are therefore not to be understood as limiting but rather only as a descriptive basis that offers guidance to the person skilled in the art in this field of technology in order to use the present invention in diverse ways.

The expression “and/or” that is used in this case if it is used in a series of two or multiple elements means that each of the stated elements may be used alone or each combination of two or more of the stated elements may be used. If by way of example a composition is described that includes the components X, Y and/or Z, the composition may include X alone; Y alone; Z alone; X and Y in combination; X and Z in combination; Y and Z in combination; or X, Y and Z in combination.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle comprising:
a wheel movably attached to a chassis;
an electric actuator connected to the wheel and the chassis to apply a force therebetween; and
a control unit configured to control the force of the electric actuator as a function of a frequency of the wheel to damp movement of the wheel relative to the chassis via an open loop control.

2. The vehicle of claim 1 wherein the control unit is configured to apply a transfer function for the open loop control of the actuator, the transfer function being dependent on the frequency of the wheel, a mass of the wheel, a tire spring stiffness, and a tire damping coefficient.

3. The vehicle of claim 1, wherein the control unit is configured to apply a transfer function for the open loop control of the actuator as:
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
wherein each of the coefficients are predefined values, and s is the frequency.

4. The vehicle of claim 1, wherein the control unit is configured to apply a transfer function for the open loop control of the actuator as:
G_{F}(s)=G_{A}(s)·G_{P}(s);
wherein
$${G}_{A} ( s ) = \frac{2 \frac{δ}{{ω}_{0}} s + 1}{\frac{1}{{ω}_{0}^{2}} {s}^{2} + 2 \frac{δ}{{ω}_{0}} s + 1} , δ = \frac{d}{2 m} and {ω}_{0} = \sqrt{\frac{c}{m}}$$
and wherein s is the frequency, m is a mass of the wheel, c is a tire spring stiffness and d is a tire damping coefficient; and
wherein
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
and each of the coefficients are predefined values.

5. The vehicle of claim 4, wherein the transfer function is tuned using G_{P}(s) to provide a phase lag of zero degrees.

6. A method of controlling a vehicle to reduce wheel hop, the method comprising, in response to movement between a wheel and a chassis, controlling an electric actuator connected to the wheel and the chassis to apply a force therebetween to damp movement of the wheel relative to the chassis via a control unit implementing an open loop control, wherein the force is a function of a frequency of the wheel.

7. The method of claim 6 further comprising applying a transfer function for the open loop control of the actuator via the control unit, the transfer function being a function of the frequency, a mass of the wheel, a tire spring stiffness and a tire damping coefficient.

8. The method of claim 6, further comprising applying a transfer function for the open loop control of the actuator as:
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
wherein each of the coefficients are predefined values, and s is the frequency.

9. The method of claim 6, further comprising applying a transfer function for the open loop control of the actuator as:
G_{F}(s)=G_{A}(s)·G_{P}(s);
wherein
$${G}_{A} ( s ) = \frac{2 \frac{δ}{{ω}_{0}} s + 1}{\frac{1}{{ω}_{0}^{2}} {s}^{2} + 2 \frac{δ}{{ω}_{0}} s + 1} , δ = \frac{d}{2 m} and {ω}_{0} = \sqrt{\frac{c}{m}}$$
and wherein s is the frequency, m is a mass of the wheel, c is a tire spring stiffness and d is a tire damping coefficient; and
wherein
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
with each of the coefficients as predefined values.

10. The method of claim 9, wherein the transfer function is tuned using G_{P}(s) to provide a phase lag of zero degrees.

11. A compensating method for avoiding a bouncing movement of a wheel of a vehicle, the method comprising:
providing an unsprung mass attached in a movable manner to a sprung mass, the unsprung mass comprising the wheel and an actuator configured to apply a force between the sprung mass and the unsprung mass; and
applying the force between the sprung mass and the unsprung mass to damp a movement therebetween during the movement of the unsprung mass relative to the sprung mass via an open loop control of the actuator.

12. The compensating method of claim 11, wherein the force is applied in dependence upon a frequency of the movement of the unsprung mass relative to the sprung mass.

13. The compensating method of claim 12, further comprising applying a transfer function for the open loop control of the actuator as:
$${G}_{A} ( s ) = \frac{2 \frac{δ}{{ω}_{0}} s + 1}{\frac{1}{{ω}_{0}^{2}} {s}^{2} + 2 \frac{δ}{{ω}_{0}} s + 1} ,$$
wherein
$$δ = \frac{d}{2 m} and {ω}_{0} = \sqrt{\frac{c}{m}}$$
and wherein s is the frequency, m is the unsprung mass, c is a tire spring stiffness, and d is a tire damping coefficient.

14. The compensating method of claim 13, further comprising applying another transfer function for the open loop control of the actuator as:
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
wherein s is the frequency and the coefficients are predetermined values.

15. The compensating method of claim 12, further comprising applying another transfer function for the open loop control of the actuator as:
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
wherein s is the frequency and the coefficients are predetermined values.

16. The compensating method of claim 11, further comprising applying a transfer function for the open loop control of the actuator as:
G_{F}(s)=G_{A}(s)·G_{P}(s);
wherein
$${G}_{A} ( s ) = \frac{2 \frac{δ}{{ω}_{0}} s + 1}{\frac{1}{{ω}_{0}^{2}} {s}^{2} + 2 \frac{δ}{{ω}_{0}} s + 1} , δ = \frac{d}{2 m} and {ω}_{0} = \sqrt{\frac{c}{m}}$$
and wherein s is a frequency of a movement of the unsprung mass relative to the sprung mass, m is the unsprung mass, c is a tire spring stiffness and d is a tire damping coefficient; and
wherein
$${G}_{P} ( s ) = \frac{{a}_{P 2} {s}^{2} + {a}_{P 1} s + {a}_{P 0}}{{b}_{P 2} {s}^{2} + {b}_{P 1} s + {b}_{P 0}} ,$$
with each of the coefficients as predefined values.

17. The compensating method of claim 16 wherein
$${G}_{F} ( s ) = {G}_{A} ( s ) \cdot {G}_{P} ( s ) = \frac{\begin{matrix}{a}_{A 1} {a}_{P 2} {s}^{3} + ( {a}_{A 1} {a}_{P 1} + {a}_{A 0} {a}_{P 2} ) {s}^{2} + \\ ( {a}_{A 1} {a}_{P 0} + {a}_{A 0} {a}_{P 1} ) s + {a}_{A 0} {a}_{P 0}\end{matrix}}{\begin{matrix}{b}_{A 2} {b}_{P 2} {s}^{4} + ( {b}_{A 2} {b}_{P 1} + {b}_{A 1} {b}_{P 2} ) {s}^{3} + \\ ( {b}_{A 2} {b}_{P 0} + {b}_{A 1} {b}_{P 1} + {b}_{A 0} {b}_{P 2} ) {s}^{2} + \\ ( {b}_{A 1} {b}_{P 0} + {b}_{A 0} {b}_{P 1} ) s + {b}_{A 0} {b}_{P 0}\end{matrix}} .$$
